(19) United States
(12) Patent Application Publication
(10) Pub. No.: US 2005/0257800 A1
(43) Pub. Date: Nov. 24, 2005

(54) Hair care equipment

(75) Inventor: Yasushi Inoue, Kagawa (JP)

Correspondence Address: DARBY & DARBY P.C., P. O. BOX 5257, NEW YORK, NY, 10150-5257, US

(73) Assignee: Uni-Charm Corporation, Shikokuchuo-shi (JP)

(21) Appl. No.: 11/133,164

(22) Filed: May 18, 2005

(30) Foreign Application Priority Data
May 18, 2004 (JP) 2004-148225

(51) Int. Cl. A45D 24/22; B67D 5/00; A45D 24/04

(52) U.S. Cl. 132/114; 132/137

(57) ABSTRACT

A hair care equipment has: a brush part, having a plurality of projections; and a liquid-containing-part, connected in a separable manner to the brush part; the above-mentioned brush part in turn comprising: a projection assembly, having at least one liquid introduction projection, which is equipped in the interior with an outflow hole that enables a liquid stored in the above-mentioned liquid-containing part to flow out from a tip; and a supporting body, equipped with a supporting member, which replaceably supports the projection assembly, and a mounting member, onto which the above-mentioned liquid-containing part can be mounted, and having introduction holes, which introduce the liquid from the liquid-containing part and communicate with the above-mentioned outflow holes in the state in which the projection assembly and the supporting body are coupled.

### CROSS-REFERENCE TO RELATED APPLICATIONS

This application is based upon and claims the benefit of priority from Japanese Patent application No. 2004-148225 filed on May 18, 2004, the entire contents of which is incorporated herein by reference.

### FIELD OF THE INVENTION

The present invention relates to a hair care equipment, and more specifically relates to a hair care equipment, having a container, which contains a washing solution or other liquid, and a brush part, from which the liquid can flow out, and being for directly applying the liquid to hair or scalp, etc., while washing or styling hair and other body hair.

### RELATED ART

Up until now, bedridden people, who cannot move their bodies freely, and, who are restricted in movement due to illness, injury, etc., cleaned their hair using dry shampoo or a warm-water wringed towel, etc. However, with such methods, though dirt on the periphery of the hair can be removed, it was difficult to eliminate dirt on skin and itching. Also, for elderly and women of weak gripping power and strength as well as for people working as caretakers of physically challenged persons, hair washing, including prior preparations, etc., is a burdening task of extremely heavy labor and thus the frequency of hair washing tended to be low. A handy body hair washing equipment, with which hair and other body hair can be washed and styled readily, is thus desired.

In regard to this point, there are the hair brushes, which are disclosed, for example, in Japanese Published Unexamined Patent Application No. H10-313947 and Japanese Published Unexamined Patent Application No. H11-46865 that provide arrangements wherein a hair growth tonic, styling tonic, or other liquid is made to flow out from a container containing the liquid to a brush surface via liquid guiding paths and be applied directly onto hair from the brush surface to perform styling, etc. The hair brush disclosed in Japanese Published Unexamined Patent Application No. H10-313947 which has a structure, wherein a hair growth tonic, styling tonic, or other tonic is placed in a portion of a handle or a mounted bottle part and the tonic is made to pass through narrow tubes inside the brush and seep out from tip parts of the brush. Also, the hair brush disclosed in Japanese Published Unexamined Patent Application No. H11-46865 which comprises: a bottle-shaped drug solution storage chamber; which stores a liquid, and a brush part; has drug solution guiding paths that join the solution storage chamber to a hollow drug solution filling chamber, and is of a structure wherein a drug solution is seeped out from tip parts of bristles mounted to the brush part.

However, with the above hairbrushes, though washing or styling hair while massaging the head can be performed while making a washing solution or other liquid seep out from tip parts of the brush or from tip parts of bristles, if the brush is provided with rigidity in order to prevent the brush from deforming during styling, etc., even the tip parts of the brush or hollow bristles of thick diameter, which contact scalp, become high in rigidity as well, thus leading to the possibility of irritating the scalp strongly and damaging skin. On the other hand, if the tip parts of the brush or the hollow bristles of thick diameter are made low in rigidity so as not to damage the skin, the bottle part and the brush body will also be made low in rigidity and become deformed during styling, etc.

The present invention has been made in view of the above issues and an object thereof is to provide a handy hair care equipment, with which by the pressing by hand of a container, containing a washing solution or other liquid, the liquid can be made to flow out from a brush part, connected to the container, and be applied onto hair or scalp and which has both a strength, such that deformation during hair washing, etc., will not occur, and a flexibility, such that protruding parts for massaging scalp will not damage skin, at the same time.

### SUMMARY OF THE INVENTION

In order to achieve the above object, the present invention is characterized in that the teeth of a brush, to be mounted onto a container, are made to have protruding parts, processed so as to be able to guide liquid, and the protruding parts and a base, supporting the protruding parts, are made separable to enable a liquid to flow out from the tips of a brush part and yet enable the rigidity of the portions of the teeth of the brush to be adjusted and replaced simply and enable prevention of leakage of the liquid as well.

In particular, the present invention provides the following.

A hair care equipment for humans or animals, including a brush part and a liquid-containing part being connected in a separable manner, wherein the brush part comprises a projection assembly, equipping a plurality of projections; and a base plate, positioned at the bases of the projections; and a supporting body, equipping a coupling part, detachably coupled to the projection assembly; the projection assembly has at least one liquid seepage projection, each equipping in its interior an outflow hole through which a liquid can flow out from the base to a hole at a tip: the supporting body has, an introduction hole for introducing the liquid inside the liquid-containing part at position opposing the liquid seepage projection; and wherein in the state in which the projection assembly and the supporting body are coupled, the outflow hole and the introduction hole are connected to form a communicating hole.

With the present invention, since the projection assembly and the supporting body of the brush part are separate bodies, the projection assembly and the supporting body can be formed of raw materials that differ in rigidity. Thus, by making the projection assembly, which contact to scalp, be flexible and low in rigidity so as not to damage the scalp and making the supporting body that supports the projection assembly be high in rigidity and difficult to deform, the brush part can be made so as not to deform even when hair washing, styling, etc., is performed while brushing the scalp and yet not damage the scalp or skin. Also, since the hardness of the projection assembly can be changed according to a user's choice, hair washing, etc., that is comfortable for each person is enabled. Furthermore, even when the projection becomes broken, worn, or degraded upon being rubbed back and forth and to left and right in the massaging process, since just the projection assembly can be replaced, an economical arrangement is provided.

As the coupling part of the supporting body to which the projection assembly is mounted, for example, there is an arrangement, wherein an opening, into which the projection assembly can be inserted and having a fitting groove formed along its outer peripheral edge at the inner surface side of the outer peripheral edge, is provided and the peripheral edge portion of the base plate of the projection assembly is fitted into the fitting groove. In the process of attachment or detachment, the above-mentioned supporting body may be curved so as to spread the opening or the above-mentioned base plate may be inserted in a folding manner into the opening of the supporting member.

Also, with the present invention, since one or more of the projections is a liquid seepage projection equipped with an outflow hole that passes through from the base portion to the tip portion, a washing solution or other liquid can be made to flow out from the tip portions of these projections and applied to scalp or skin. Since this does away with the need to use a washing solution, etc. that is contained in a separate container while massaging with the brush, hair washing, styling, etc. can be carried out efficiently and simply. Also, since the liquid is applied directly to the scalp or skin and can thus be attached to hair, scalp, etc., efficiently, the arrangement is economical in that a low usage amount of washing solution or other liquid suffices. Furthermore, by the usage amount being made low, the liquid-containing part itself can be made compact, be of a weight and size enabling holding by one hand, and be such that will not tire a wrist. Thus, even bedridden people, who cannot move their bodies freely, and people, who are restricted in movement due to illness, injury, etc., can perform hair washing and styling readily while lying down on a bed or futon. Also, for elderly and women of weak gripping power and strength as well as for people working as caretakers of physically challenged persons, easy hair washing is enabled and a large burden will not be placed even when the frequency of hair washing is high.

Furthermore, with the present invention, the above-mentioned outflow hole are united with the introduction hole provided in the supporting body to form communicating hole that enable the passage of the liquid. Leakage of the liquid can thus be prevented even if the projection assembly and the supporting body are made separable and washing tasks can be carried out comfortably without hands coming contact with the liquid more than necessary.

In addition, with the present invention, the liquid-containing part and the brush part are enabled to be mounted and removed freely at the coupling part. Replenishment of the liquid from the coupling part of the liquid-containing part is thus enabled, and replace to a liquid suited to a user, adjustment of quantity, etc., can also be performed readily.

In the present specification, “hair care equipment” refers to equipment enabling the washing of hair and scalp of humans and body hair and dermis (skin) of animals, massaging for hair growth and prevention of hair loss, styling by brushing, and other tasks effective for hair, scalp or skin.

The hair care equipment according to the above embodiment, wherein the projection assembly has a protruding part, protruding from a non-projection surface of the base plate at a position which is opposite to a position where the liquid seepage projection is positioned and having a shape and size enabling to fit into an opening of the introduction hole, which is directed toward the projection assembly, or a recessed part having the opening, and wherein inside each of the protruding part, the outflow hole is disposed so as to extend from the interior of the liquid seepage projection to the interior of the protruding part, and in the state of being fitted into the opening or the recessed part, the outflow hole is connected with the introduction hole to form the communicating hole.

With the present invention, the projection assembly has formed thereon protruding part, protruding from a non-projection surface at which the liquid seepage projection is positioned, and by the protruding part being fitted into opening of the introduction hole of the supporting body or having the opening, the protruding part of the liquid seepage projection is put in close contact with the introduction hole, the outflow hole formed in the liquid seepage projection and the introduction hole formed in the supporting body is put in secure communication, and flow path for liquid are thus secured. Also, since the outflow hole inside the protruding part and the introduction holes of the supporting body become connected and fixed, even if liquid is ejected from the liquid-containing part, the liquid will be conveyed without fail to the outflow hole.

Another embodiment of hair care equipment, wherein the supporting body has a protruding part, protruding from a surface facing the projection assembly at which the introduction hole is positioned and having a shape and size enabling to fit into an opening of the outflow hole, which is positioned in internal part of the base plate and that are positioned at the bases of the liquid seepage projection, or into a recessed part having the opening, and wherein inside each of the protruding part, the introduction hole is disposed so as to extend from the interior of the supporting body, and in the state in which the protruding part is fitted into the opening or the recessed part, the outflow hole are connected with the introduction hole to form the communicating hole.

With the present invention, protruding part is formed on the supporting body so as to protrude at the position of the above-mentioned introduction hole, and moreover, these protruding part have a shape and size enabling fitting into opening of the outflow hole, positioned in the interior of the base part of the liquid seepage projection or into recessed part formed on the opening. Thus, by the fitting of the protruding part into the outflow hole inside the liquid seepage projections or into the recessed part, the outflow hole formed in the liquid seepage projection and the introduction hole formed in the supporting body are put in secure communication and flow path for liquid is thus secured. Also, since the liquid seepage projection of the projection assembly and the supporting body become connected and fixed, even if liquid is ejected from the liquid-containing part, the liquid will be conveyed without fail to the outflow hole and leakage of liquid can be prevented.

In a further embodiment hair care equipment according to the above embodiments, wherein the projection assembly has a first protruding part, protruding from the non-projection surface of the base plate at a position which is opposite to a position where the seepage projection is positioned and having the outflow hole formed in the interior thereof so as to be continuous from the interior of the liquid seepage projection: the supporting body has a receiving part, protruding from the position of the surface facing the projection assembly at which the introduction hole is positioned and having introduction hole formed in the interior thereof in continuation to the introduction hole from the interior of the supporting body; and wherein the outflow hole and the introduction hole is connected to form the communicating hole by the receiving part being fitted into the outflow holes inside the first protruding part or by the first protruding part being fitted into the introduction holes inside the receiving part.

With the present invention, the first protruding part, formed on the projection assembly, and the receiving part, formed on the supporting body, are fitted and put in close, mutual contact. The outflow holes, continuing from the interiors of the liquid seepage projection, and the introduction hole, continuing from the interior of the supporting body, are thus put in secure communication and flow path for liquid are secured. The liquid ejected from the liquid-containing part is thus conveyed without fail from the introduction hole to the outflow hole and leakage of liquid will not occur.

The hair care equipment according to any of the previous embodiments, wherein the projection assembly is equipped with a first projection set, having a liquid seepage projection in which the outflow hole is formed, and a second projection set, having projection without the communicating hole, the liquid seepage projection of the first projection set having a length dimension shorter than the projection of the second projection set.

With the present invention, since the first projection set and the second projection set differ in projection length, even when the tip parts of the projection of the second projection set contact scalp, the tip parts of the liquid seepage projection of the first projection set will not be in contact with the scalp. The opening of the outflow holes formed in the liquid seepage projections of the first projection set will therefore not be closed by the scalp and since liquid can be supplied at any time while performing a washing action, good usability is realized.

An embodiment of hair care equipment, wherein the above-mentioned projection assembly is low in rigidity in comparison to the above-mentioned supporting body.

With the present invention, since the projection assembly is lower in rigidity than the supporting member, flexibility that is gentle to scalp and hair can be provided even though the brush as a whole has rigidity such that deformation will not occur during hair washing. That is, since the projection assembly can be formed of a flexible material, the scalp will not be damaged even if hair washing or styling is performed while performing brushing. Meanwhile, since the supporting body is higher in rigidity than the projection assembly, it can be formed of a material with which deformation will not occur readily and the shape of the brush part itself can be maintained. As such a material for the supporting body, a material, having a rigidity and a strength at least such that deformation will not occur in the tasks of attachment and detachment with respect to the liquid-containing part and in massaging, brushing, etc., during hair washing and styling, is preferable.

The hair care equipment according to any of the above embodiments, wherein the supporting body has a supporting member supporting the projection assembly, and a mounting member mounting the liquid-containing part, the liquid-containing part is equipped with a liquid supplying opening, which is an opening for supplying the liquid to the brush part, and a mounted member for being mounted to the supporting body, and the mounting member and the mounted member are coupled by being screwed together.

With the present invention, the brush part and the liquid-containing part are connected by coupling the supporting member, provided at the supporting body of the brush part, and the mounted member, provided at the liquid-containing part. This coupling part can be arranged by providing threads, respectively, at the mounting member and the mounted member so as to enable screwing, and this structure is especially effective in the case where this coupling part is to be provided with a liquid adjustment function, to be described below.

The hair care equipment according to any of the above embodiments, wherein a disk-like cap having one or more ejection holes formed therein for ejecting liquid which number is greater than or equal to the number of the introduction hole, is mounted to a mounted member of the liquid-containing part, the introduction hole and the ejection hole are formed along a circumference of a fixed radius from the center of rotation when the brush part and/or the liquid-containing part are rotated, and a user is enabled to adjust the amount of liquid supplied to the brush part by rotating the supporting member and/or the liquid-containing part.

With the present invention, the introduction hole, formed on the upper surface of the mounting member of the supporting body, and the ejection hole, formed on the cap of the liquid-containing container, is formed along the same circumference at the same distance from the center of the same circle. Thus, by rotating one of either or both the supporting member and the cap, the introduction hole and the ejection hole can be made to communicate or not communicate and by making the holes be shifted slightly with respect to each other, the size of the communicating hole can be changed. Furthermore, since the number of communicating hole can be adjusted by differing the number of introduction hole and the number of ejection hole, fine adjustment of the amount of liquid flowing out from the brush part is enabled.

Another embodiment of the hair care equipment according to the previous embodiment, wherein at least one of the above-mentioned ejection holes has its outer extension raised from a surface facing the above-mentioned supporting member to enable the user to detect the position of the above-mentioned ejection hole upon rotation of the above-mentioned brush part.

With the present invention, since the periphery of an ejection hole is raised slightly, when an introduction hole of the supporting body becomes positioned at the inner side of the raised portion, the sensation thereof is transmitted to the user. The communication of the ejection holes and the introduction holes can thus be confirmed without the need for visual recognition.

The hair care equipment according to any of the previous embodiments, wherein at least a part of the above-mentioned liquid-containing part is pressingly deformable.

With the present invention, since the liquid-containing part, which can store a liquid, is made pressingly deformable, a user can suitably change the amount of liquid supplied to the brush part by adjusting the pressing force. Liquid of an amount suitable for a washing task, etc., can thus be used readily.

With the present invention, since the projection assembly and the supporting body are arranged as separate bodies, the supporting body and the projection assembly can be made to differ in rigidity so that even if the projection assembly is made of material having flexibility such that scalp will not be damaged, the supporting member can be made of material of high rigidity and high strength. Hair washing and styling can thus be performed without damaging the scalp, and yet the brush part will not deform during the tasks of hair washing, styling. Also, since the rigidity of the projection assembly can be changed readily by changing the number of brush teeth (density of the projections) or the material, comfortable hair washing, can be performed upon selecting the degree of stimulation of skin during hair washing, according to choice. Moreover, since the projection assembly and the supporting body are arranged to be mounted detachably, the arrangement is economical in that just the projection assembly needs to be replaced when the projections become worn, degraded, or broken or when a change to a brush rigidity or projection density of choice is to be performed.

Also, since the washing solution or other liquid, stored in the liquid-containing part, is enabled to flow out onto hair or scalp through communicating holes, formed by the communication of outflow holes, formed in the projection assembly, and introduction holes, formed in the supporting body, the washing solution or other liquid will be applied efficiently onto a scalp surface. Washing and styling while performing massaging using the tip parts of the projection can thus be performed to eliminate dirt on hair and dirt and itching of skin with a low usage amount, and body hairs can thus be cleaned readily without having to prepare a large amount of warm water or a basin or other container. Also, since the usage amount of washing solution or other liquid is low, the liquid-containing part can be made compact. A handy arrangement, which has a weight and size that enable, holding by one hand and which will not tire the wrist during work, is thus made possible. Hair washing can thus performed easily by people who are disabled or weak as well as by people working as caretakers, etc., and furthermore, hair washing can be performed easily during camping and other outdoor activities.

### BRIEF DESCRIPTION OF THE DRAWINGS

FIG. 1 is depicts a perspective view showing a first embodiment of the present invention's hair care equipment.

FIG. 2 is depicts a longitudinal section of the hair care equipment shown in FIG. 1.

FIG. 3A is depicts diagrams showing a brush part of the hair care equipment shown in FIG. 1, being a sectional view of a projection assembly and a supporting body that make up the brush part.

FIG. 3B is depicts being a sectional view of the state in which the projection assembly is mounted to the supporting body.

FIG. 4 is depicts a schematic view for describing the state in which a washing solution or other liquid flows out from tip parts of the brush part upon pressing of a liquid-containing part that contains the liquid.

FIG. 5A is depicts diagrams showing another embodiment for connecting outflow holes of the projection assembly and introduction holes of the supporting body.

FIG. 5B is depicts diagrams showing another embodiment for connecting outflow holes of the projection assembly and introduction holes of the supporting body.

FIG. 6 is depicts a perspective view showing a second embodiment of the present invention's hair care equipment.

FIG. 7 is depicts a longitudinal sectional view of the hair care equipment shown in FIG. 6.

FIG. 8A is depicts diagrams illustrating a brush part of the hair care equipment shown in FIG. 6, being a front view of the brush part as viewed from the front.

FIG. 8B is depicts diagrams illustrating a brush part of the hair care equipment shown in FIG. 6, being a sectional view taken along line A-A.

FIG. 8C is depicts diagrams illustrating a brush part of the hair care equipment shown in FIG. 6, being a section view of a projection assembly and a supporting body that make up the brush part of FIG. 8B.

FIG. 9 is depicts a longitudinal view showing a third embodiment of the present invention's hair care equipment.

FIG. 10A is depicts diagrams for describing a liquid-containing part shown in FIG. 9, being a partial sectional view showing a liquid supplying opening of the liquid-containing part.

FIG. 10B is depicts diagrams for describing a liquid-containing part shown in FIG. 9, being an enlarged perspective view of FIG. 10A.

FIG. 11A is depicts schematic diagrams for describing the positioning of introduction holes, formed in a brush part, and ejection holes, formed in a cap of the liquid-containing part, being a diagram for describing the positioning of the ejection holes.

FIG. 11B is depicts schematic diagrams for describing the positioning of introduction holes, formed in a brush part, and ejection holes, formed in a cap of the liquid-containing part, being a diagram for describing the positioning of the introduction holes.

### DESCRIPTION OF THE PREFERRED EMBODIMENTS

Embodiments of the present invention's hair care equipment shall now be described based on the drawings, etc. Though for the sake of description, cases, where the present invention's hair care equipment is used as washing equipment for human hair, shall mainly be described, the present invention is not limited thereto.

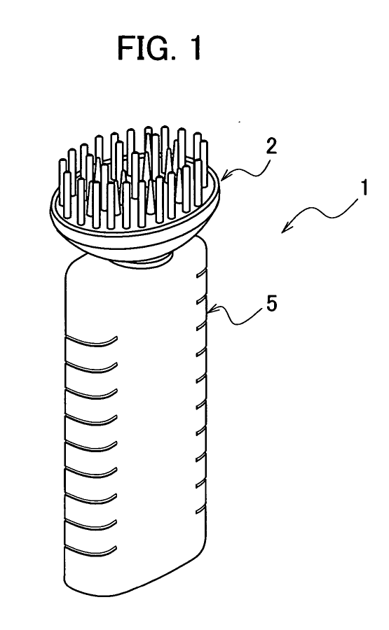

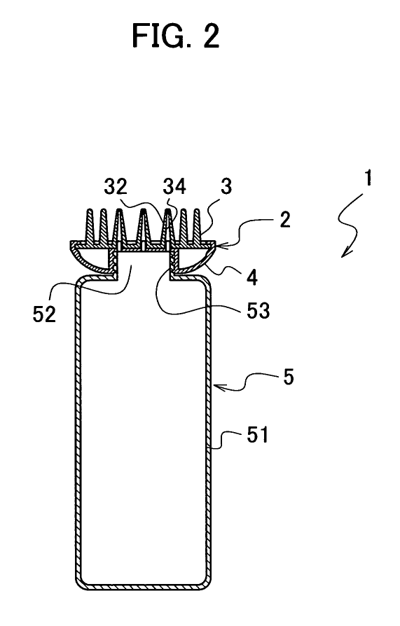

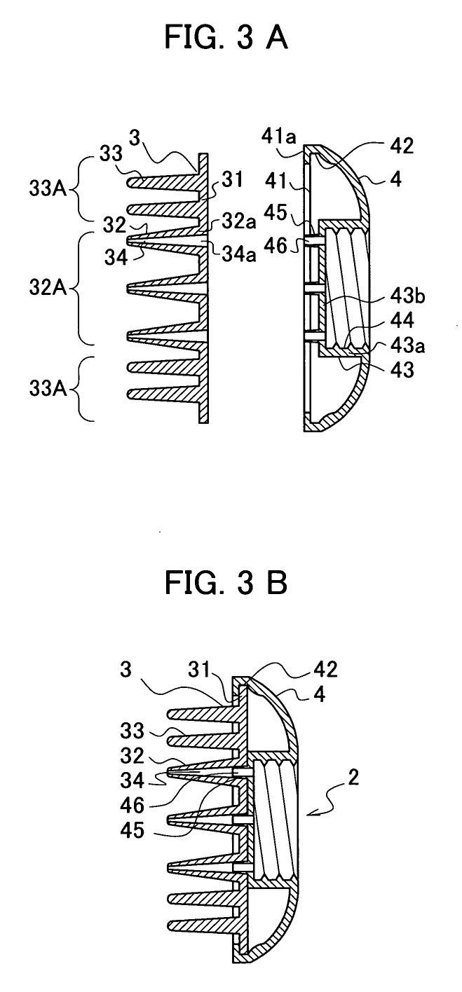

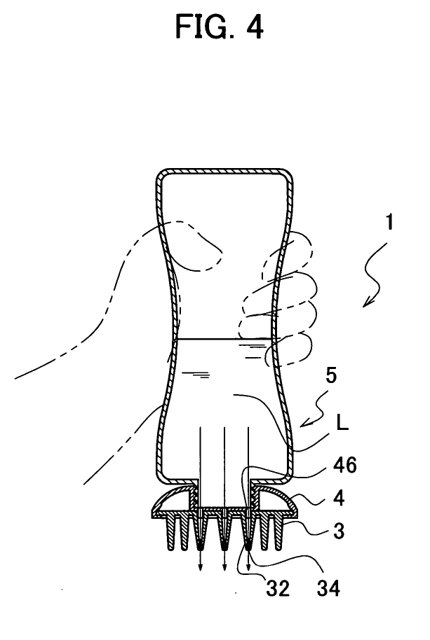

FIG. 1 is a perspective view showing an embodiment of the present invention's hair care equipment. FIG. 2 is a longitudinal section of the hair care equipment shown in FIG. 1, and FIG. 3A FIG. 3B shows diagrams showing a brush part of the hair care equipment shown in FIG. 1, with FIG. 3A being a sectional view of a projection assembly and a supporting body that make up the brush part and FIG. 3B being a sectional view of the state in which the projection assembly is mounted to the supporting body. FIG. 4 is a schematic view for describing the state in which a washing solution or other liquid flows out from tip parts of the brush part upon pressing of a liquid-containing part that contains the liquid. In the figures, the dimensions, etc., are adjusted suitably to enable easy comprehension.

<Arrangement>

In FIG. 1 and FIG. 2, hair care equipment, indicated by attached symbol 1, is arranged with a brush part 2 and a liquid-containing part 5 as the main elements, and a supporting body 4 of the brush part 2 is mounted by screwing onto a liquid supplying opening 52 of the liquid-containing part 5.

As shown in FIG. 3A, the brush part 2 comprises a projection assembly 3 and the supporting body 4, and the supporting body 4 has a fitting groove 42 at the periphery of an opening 41 for the mounting of the projection assembly 3. Thus, as shown in FIG. 3B, by the fitting of the outer peripheral edge of a base plate 31 of the projection assembly 3 into the fitting groove 42, the projection assembly 3 is mounted securely onto and unified with the supporting body 4 to form the brush part 2.

As shown in FIG. 3A, the projection assembly 3, which makes up the brush part 2, is arranged with a first projection set 32A, comprising liquid seepage projections 32, and a second projection set 33A, comprising normal projections 33, being formed integrally on a base plate 31, positioned at the base. Each liquid seepage projection 32 has formed therein an outflow hole 34, which passes through from a base portion 32a to a tip portion, so that a liquid can flow through the interior thereof. Meanwhile, the projections 33 do not have the outflow holes 34 formed therein and are arranged so that a liquid will not flow through. Though in the present embodiment, the outflow holes 34 are of a shape such that the interiors of the liquid seepage projections 32 are gouged out in conical form, the outflow holes are not limited thereto. Also, though the front end of each outflow hole 34 is formed so as to be opened at the tip part of the corresponding liquid seepage projection 32, the present invention is not limited thereto, and each outflow hole 34 may be formed so as to open at an outer peripheral wall part of the tip portion of the corresponding liquid seepage projection 32 or formed so as to open both at the tip part and an outer peripheral wall part.

With the present invention, as the second projection set 33A surround the first projection set 32A it is arranged to the perimeter domain of the base plate 31, so that its hair can be washing, massaging efficiently the scalp of the part to which liquids, such as washing liquid which flowed out of the tip part of the brush part 2, were applied by the projections 33 of the second projection set. And at a central region, the liquid seepage projections 32 of the first projection set 32A and the projections 33 of the second projection set 33A are positioned in a mixed manner. Also, the liquid seepage projections 32 of the first projection set 32A and the projections 33 of the second projection set 33A are made to have a conical shape, line-like shape, or other shape of the same types as those of projections of a normal hair brush. However, the positions and shapes are not limited to these.

The material forming the projection assembly 3 is not restricted in particular as long as it is a material with which the first projection set 32A and the second projection set 33A will have a flexibility of a degree such that scalp will not be damaged and the base plate 31 will have a flexibility of a degree enabling deformation by hand for fitting and mounting the outer peripheral edge thereof in the fitting groove 42 formed in the supporting body 4. For example, such a material, synthetic resins, such as polyethylene (PE), polypropylene (PP), nylon, silicon, elastomer, etc., and rubber and other elastic bodies can be cited.

As shown in FIG. 3A, the supporting body 4 is formed to have a substantially concave-mirror-like shape that is circular in plan view and so as to have an opening into which the base plate 31 can be inserted, and a peripheral edge part 41a at the upper surface side (in the direction of the projection assembly) is formed to the form of an inner collar. In particular, the fitting groove 42 is formed in the peripheral edge part 41a of the opening 41 of the supporting body 4 of arcuate cross-sectional shape so as to enable the fitting in of the outer peripheral edge of the base plate 31 as shown in FIG. 3B.

A mounting member 43, which is for mounting onto the liquid-containing part, has a substantially cylindrical shape, and protrudes inwards (in the direction of the projection assembly), is formed at a substantially central portion of the supporting body 4. This mounting member 43 is opened at the outer side (in the opposite direction of the projection assembly) and has threads 44 formed on a side wall 43a. These threads 44 can be screwed onto a mounted member, having the liquid supplying opening 52, to be described later, of the liquid-containing part 5, to mount the liquid-containing part 5 onto the brush part 2 (see FIG. 2).

As shown in FIG. 3A, on an upper surface part 43b of the mounting member 43, a plurality of nozzle-like protruding parts 45, which protrude in the direction of projection assembly 3, are formed at positions that oppose the first projection set 32A when the above-mentioned projection assembly 3 is mounted to the supporting body 4. These protruding parts 45 are of a size and shape enabling fitting into base portions 34a of the outflow holes 34 formed in the liquid seepage projections 32 and have introduction holes 46 formed through in the interior thereof. Thus, by the protruding parts 45 being fitted into the base portions 34a of the outflow holes 34, formed in the liquid seepage projections 32, the outflow holes 34 and the introduction holes 46 become communicated. And, since the outer walls of the protruding parts 45 are “vertical” while the base portions 34a are “tapered,” when the protruding parts 45 are inserted into the base portions 34a, the outer circumferential tips of the protruding parts 45 contact the inner circumferences of the base portions 34a over a long distance so that a good sealing state can be maintained. Since the washing solution or other liquid is thereby made to flow out from the tip portions of the brush part 2 via short and closely sealed liquid guiding paths, leakage of the liquid can be prevented. The shape of the protruding parts 45 may be changed as suited in accordance with the shape of the base portions 34a of the outflow holes 34 so that they can be fitted in close contact with the base portions 34a.

The material making up the supporting body 4 is preferably a material, having a rigidity and strength of a degree no less than that with which the brush part 2 will not become deformed by scalp massaging and brushing during hair washing or styling, and hard synthetic resins, such as polyethylene (PE), polypropylene (PP), nylon, etc., can be cited as examples.

As shown in FIG. 2, the liquid-containing part 5 comprises a main container body 51 and a liquid supplying opening 52, formed in a protruding manner on the tip part of the main container body 51, and by threads 53 being formed on the outer side surface of the liquid supplying opening 52, the mounted member is arranged. The main container body 51 is formed, at least in part, of a material that can be deformed by the pressing pressure of a hand and has a shape that can be gripped easily by one hand. Liquid is stored and held in the interior upon being poured from the liquid supplying opening 52. As examples of the material for forming the liquid-containing part 5, synthetic resins with flexibility, such as polyethylene (PE), polypropylene (PP), nylon (polyamide fibers), etc., can be cited

With the present invention's hair care equipment 1, first, the outer peripheral edge of the base plate 31 of the projection assembly 3 is fitted into the fitting groove 42, formed in the peripheral edge part 41a of the opening 41 of the supporting body 4, to thereby mount the projection assembly 3 onto the supporting body 4. In this process, the protruding parts 45, formed on the upper surface part 43b of the mounting member 43 of the supporting body 4, are fitted into the base portions 34a of the outflow holes 34 of the first projection set 32A of the projection assembly 3, thereby fixing the first projection set 32 onto the upper surface part 43b of the mounting member 43 of the supporting body 4 and putting in communication the outflow holes 34, formed in the first projection set 32, with the introduction holes 46, formed in the upper surface part 43b of the mounting member 43 of the supporting body 4. The liquid supplying opening 52 of the liquid-containing part 5, containing a liquid, is then screwed onto the mounting member 43 of the brush part 2, with which the projection assembly 3 has been mounted to the supporting body 4, to mount the supporting body 4 onto the liquid-containing part 5 (see FIG. 1 to FIG. 3B). The liquid L that is contained in the liquid-containing part 5 is thus made to flow out from the tip portions of the liquid seepage projections 3 via the introduction holes 46 of the supporting body 4 and the outflow holes 34 of the first projection set 32A of the projection assembly 3, as shown by the arrows in FIG. 4, by the pressing of the pressingly deformable liquid-containing part 5 by a hand.

Also, in washing hair, the main container body 51 is held with one hand and pressure is applied to the container as suited while performing brushing by passing the liquid seepage projections 32 and the projections 33 of the brush part 2 between hairs. By doing so, the liquid L is made to flow out from the first projection set 32A of the brush part 2 and be directly applied to the skin and, at the same time, by moving the brush part 2 back and forth and to the left and right while applying a suitable pressure to the scalp, washing while massaging can be performed with the liquid being put in contact with the scalp and the hair.

And, though by being rubbed back and forth and to the left and right, the bases of the liquid seepage projections 32 and the projections 33 may become degraded, broken, or worn, since the projection assembly 3 is a separate body from supporting body 4, periodic replacement as well as selection of the softness of projections according to a person's choice are enabled.

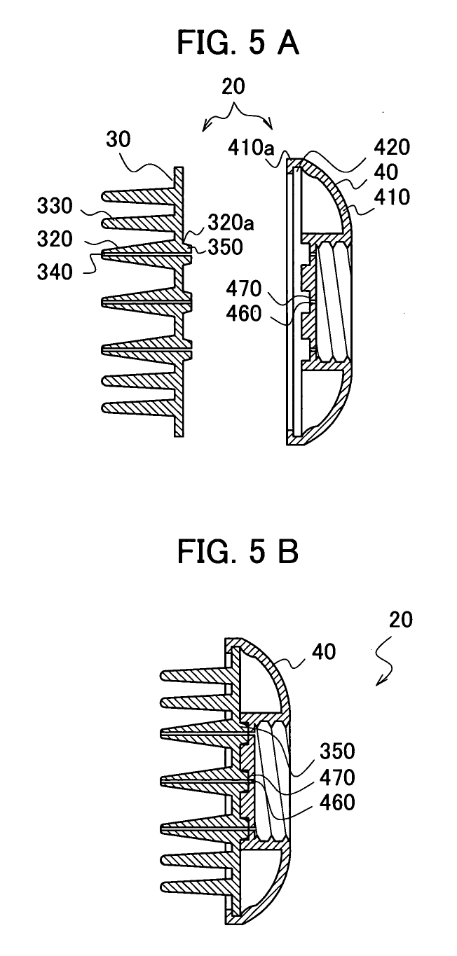

In regard to the connection of the outflow holes, formed in the first projection set of the projection assembly, and the introduction holes, formed in the upper surface of the mounting member of the supporting body, it is preferable from the standpoint of preventing leakage of liquid that one of either the protruding parts and the recessed parts, equipped with the outflow holes and introduction holes, be made to have a “tapered shape” and the other be made to have a “shape with a vertical wall.” Thus, the outer walls of the protruding parts 45 may be “vertical” and the base portions 34a may be “tapered” as shown in the above-described FIG. 3A FIG. 3B, or the protruding parts 350 may be tapered and the recessed parts 470 may be of a shape having a vertical wall as shown in FIG. 5A and FIG. 5B.

In contrast, the following disadvantages arise in the case where the protruding parts and the recessed parts have the same shape. That is, in this case, an extremely high precision of forming will be required in order to maintain a good closely-contacting state in the fitted state, and realistically speaking, there is a high possibility that gaps will form between the protruding parts and the recessed parts. Also, since the wall surfaces of both parts will be mutually vertical, it will not be easy to fit the protruding parts into the recessed parts. Furthermore, due to the protruding parts and the recessed parts being of the same shape, permanent strain will arise each time the protruding assembly is replaced and the depressed portions of the recessed parts will become enlarged gradually. On the other hand, if either the protruding parts or the recessed parts are tapered, since positioning can be performed readily in the fitting process, the protruding parts can be fitted into the recessed parts readily.

Thus, in comparison to a structure wherein both the protruding parts and the recessed parts have the same shape, it is preferable to make one of either the protruding parts and the recessed parts tapered and thereby provide a structure, with which when both parts are fitted together, the parts are first put in partial contact and thereafter press fitted to achieve close contact at the base portions.

A specific description shall now be provided in regard to FIG. 5A and FIG. 5B. FIG. 5A is a sectional view showing a projection assembly and a supporting body that make up a brush part 20 and FIG. 5B is a sectional view showing the state in which the projection assembly is mounted to the supporting body.

As shown in FIG. 5A, tapered protruding parts 350, protruding from a base plate towards the direction of mounting of the supporting body 40, are formed on base portions 320a of liquid seepage projections 320 of a first projection set, and recessed parts 470, with vertical walls, are formed on openings of introduction holes 460 of the supporting body 40. The protruding parts 350 can thus be fitted and fixed in the recessed parts 470 of the supporting body 40 as shown in FIG. 5B. Since the outer peripheral tips of the protruding parts 35 contact the inner walls of the recessed parts 470 over a long distance, a good sealing state can be maintained.

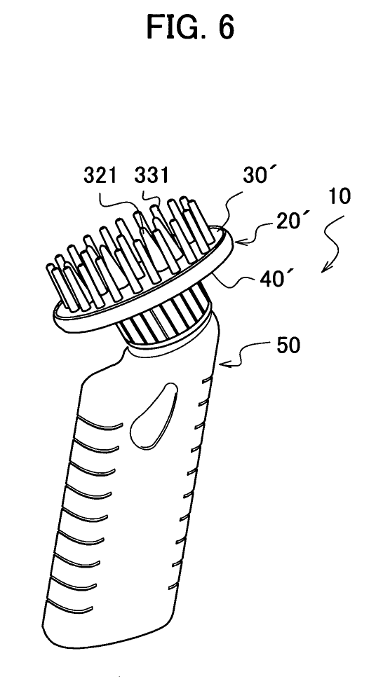

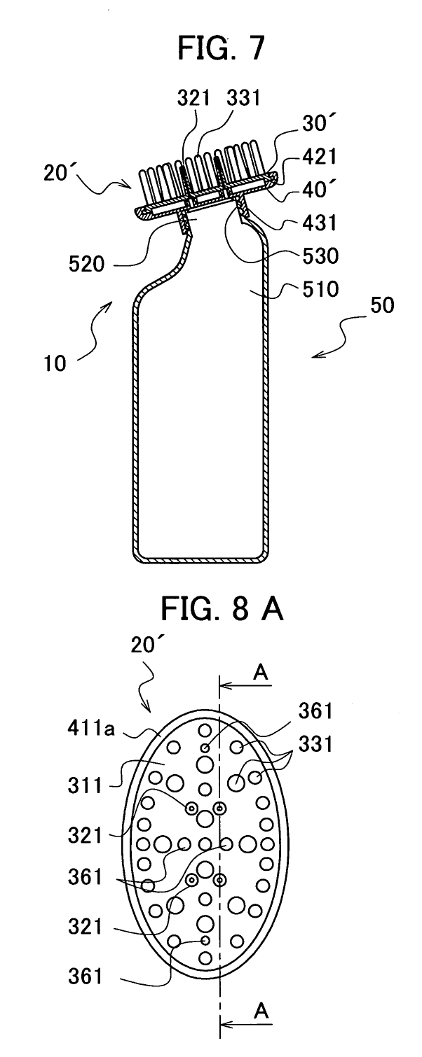

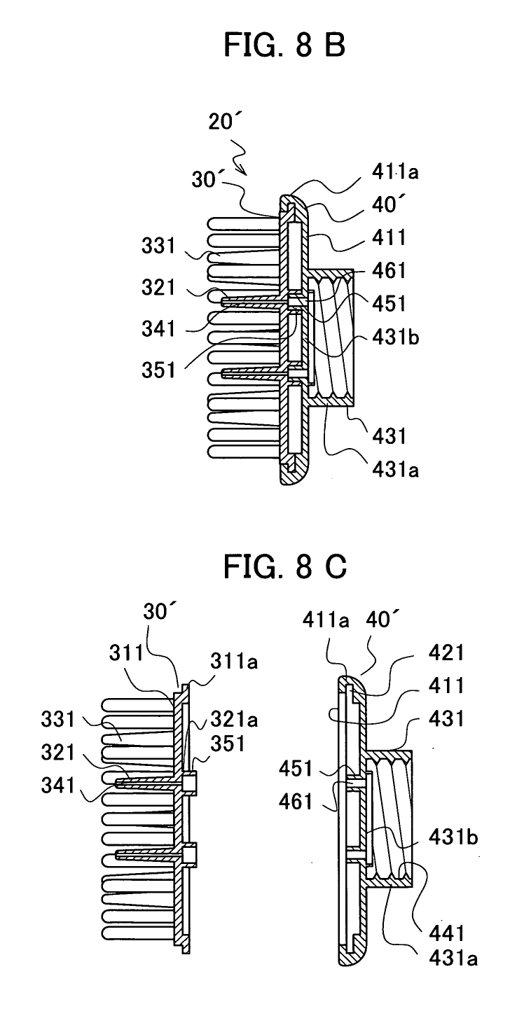

Another embodiment of the present invention's hair care equipment shall now be described. FIG. 6 is a perspective view showing the second embodiment of the present invention's hair care equipment, FIG. 7 is a longitudinal sectional view of the hair care equipment shown in FIG. 6, and FIG. 8A to FIG. 8C shows diagrams illustrating a brush part 20′ of the hair care equipment shown in FIG. 6, with FIG. 8A being a front view of the brush part 20′ as viewed from the front, FIG. 8B being a sectional view taken along line A-A, and FIG. 8C being a section view of a projection assembly and a supporting body that make up the brush part 20′ of FIG. 8B. With the following embodiment, components that are the same as the hair care equipment of the above embodiment shall be provided with the same symbols and redundant description shall be omitted. Also, in order to facilitate comprehension, the dimensions are adjusted suitably.

As with the previous embodiment, a hair care equipment 10 of the second embodiment is arranged with a brush part 20′ and a liquid-containing part 5A as the principal components, and the brush part 20′ is mounted by screwing onto a liquid supplying opening 52 of the liquid-containing part 5A (see FIG. 6 and FIG. 7).

As with the previous embodiment, the brush part 20′ comprises a projection assembly 30′ and a supporting body 40′, and the projection assembly 30′ and the supporting body 40′ are arranged to be integrated by the replaceable fitting of the outer peripheral edge of the base plate 311 of the projection assembly 30′ into the fitting groove 421 of the supporting body 41 (see FIG. 7).

As shown in FIG. 8A to FIG. 8C, the projection assembly 30′, which makes up the brush part 20′, is provided, at the base plate 311, with a plurality of liquid seepage projections 321 (four in the present embodiment), in each of which is formed an outflow hole 341 passing through from a base portion 321a to a tip portion, a plurality projections 331 (341 in the present embodiment), which do not have the outflow holes 341, and a plurality of drain holes 361 (four in the present embodiment), positioned at predetermined positions. At the base portions 321a of the liquid seepage projections 321, first protruding parts 351 of substantially cylindrical shape (U-like cross-sectional shape) are formed so as to protrude towards the outer side (in the opposite direction of the projection assembly).

As shown in FIG. 8A, in regard to the liquid seepage projections 321 and the projections 331, the projections 331 are positioned at an outer peripheral region of the base plate 311 so as to surround the liquid seepage projections 321, and at a central region, the liquid seepage projections 321 and the projections 331 are positioned in a mixed manner. Also, the liquid seepage projections 321 are formed to be shorter in length than the projections 331. By thus making the liquid seepage projections 321 short in length, since even when the tip parts of the projections 331 contact scalp, the tip parts of the liquid seepage projections 321 will not contact the scalp, the openings of the outflow holes 341 from which a liquid flows out will not be closed by the scalp, thus providing convenience of use by enabling the liquid to be supplied to the scalp or hair while performing a washing action. However, the present invention is not limited to this and the two types of projections may be made the same in length.

Also, the drain holes 361 are positioned at four positions in FIG. 8A. In many cases where the projection tips are washed after use, water enters between the protruding assembly 30′ and the supporting body 40′. The drain holes 361 are provided to enable such water to be drained out by shaking the brush part 20′. Though the number and positioning of the drain holes 361 of the present embodiment are preferable, the present invention is not limited thereto and it is sufficient that draining is enabled.

As with the previous embodiment, the material that forms the projection assembly 30′ is not restricted in particular as long as it is an elastically deformable material with which the liquid-seepage projections 321 and the projections 331 will have a flexibility of a degree such that scalp will not be damaged and the base plate 30′ will have a flexibility of a degree enabling deformation by a hand of a user so as to enable mounting by the fitting of the outer peripheral edge thereof. As examples of such a material, synthetic resins, such as polyethylene (PE), polypropylene (PP), nylon, silicon, elastomer, etc., and rubber and other elastic bodies can be cited.

As shown in FIG. 8C, the supporting body 40′ is formed to a substantially plate-like shape that is elliptical in plan view, the peripheral edge part 411a at the upper surface side (in the direction of the projection assembly) is formed to the form of an inner collar, and a fitting groove 421 is formed along the outer peripheral edge at the peripheral edge part 411a at the opening 411 side of the supporting body 40′. Also, a mounting member 431, having substantially cylindrical shape and protruding outwards (in the opposite direction of the projection assembly), is formed at a substantially central portion of the supporting body 40′. This mounting member 431 is opened at the outer side (in the opposite direction of the projection assembly) and has threads 441 formed on a side wall 431a. As with the previous embodiment, the material making up the supporting body 40′ is preferably a material having a rigidity of a degree no less than that with which the brush part 20′ will not become deformed by scalp massaging and brushing during hair washing or styling, and hard synthetic resins, such as polyethylene (PE), polypropylene (PP), nylon, etc., can be cited as examples.

With projection assembly 30′, first protruding parts 351 of substantially cylindrical shape are formed so as to protrude in the direction of the supporting body 40′ at the base portions 321a of the liquid seepage projections 321. Meanwhile, with supporting part 40′, receiving parts 451 of substantially cylindrical shape are formed to protrude in the direction of projection assembly 30′ at the upper surface part 431b of the mounting member 431, and these receiving parts 451 are positioned so as to oppose the liquid seepage projections 321 when the above-mentioned projection assembly 30′ is mounted to the supporting body 40′. Also, the receiving part 451 have a shape and dimensions enabling fitting into the first protruding parts 351 and have introduction holes 461 formed through in the interior thereof. Thus, by the fitting of the receiving part 451 into the first protruding parts 351, the outflow holes 341 inside the liquid seepage projections 321 and the introduction holes 461 inside the supporting body 40′ are put in communication.

As shown in FIG. 6 and FIG. 7, the liquid-containing part 5A comprises a main container body 510 and a liquid supplying opening 520, formed on a front end part of the main container body 510 so as to protrude outward in an inclined direction, and threads 530 are formed on the outer surface of the liquid supplying opening 520. The brush part 20′ is thus connected to the liquid-containing part 5A in an inclined direction. As with the previous embodiment, the main container body 510 is formed, at least in part, of a material that can be deformed by the pressing pressure of a hand and to have a shape that can be gripped readily and stores a liquid in the interior thereof.

The making of the brush part 20′ inclined with respect to the liquid-containing part 50 as described above is effective for use, for example, as a nursing equipment. In particular, when the head of an elderly who is bedridden is to be washed, a caretaker supports the head with one hand to lift the head from a pillow and washes the back portion of the head using the other hand, and if in this process, “the brush part is not set at an angle with respect to the liquid-containing part that is held,” the head must be lifted by an amount corresponding to the total length of the equipment. In contrast, if the brush part 20′ is mounted at an angle with respect to the liquid-containing part 50 as in the present embodiment, a distance that is slightly longer than that enabling the entry of the brush part 20′ suffices and since the distance by which the caretaker must lift the head is thus shortened, the hair washing work is facilitated.

Also, even in the case where use is to be made not as a nursing equipment but for washing the back part of one's own head, since the distance by which an arm must be raised will be shortened if the brush part is angled, holding and washing are made easy in this case as well.

The hair care equipment 10 of the current embodiment is used in the same manner as the hair care equipment of the previous embodiment.

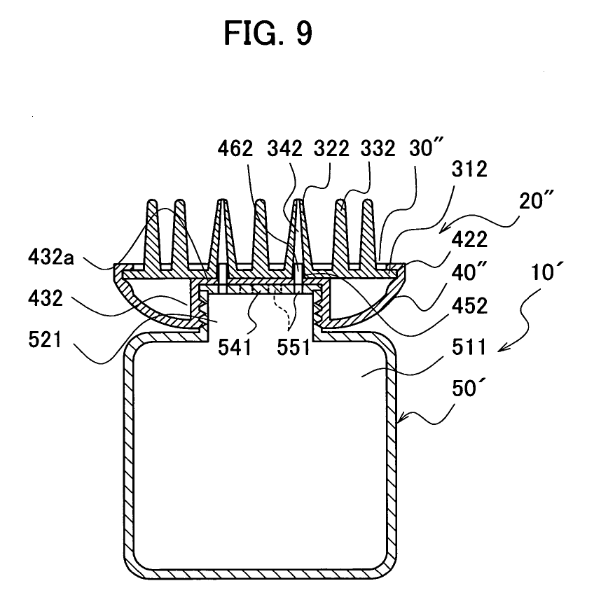

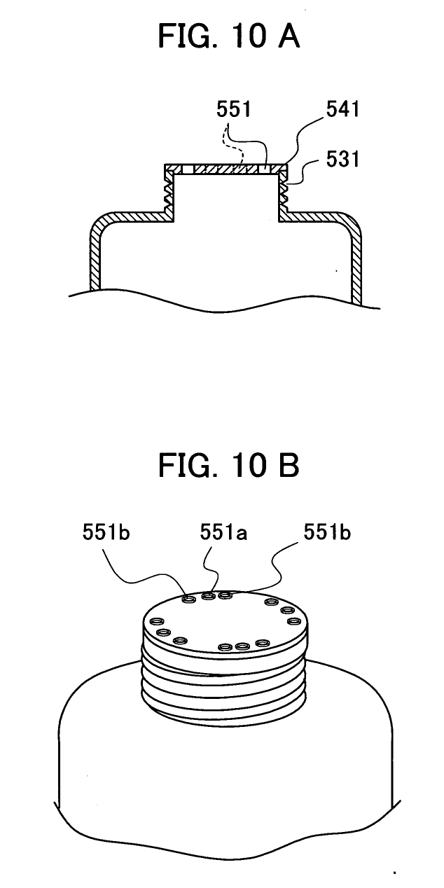

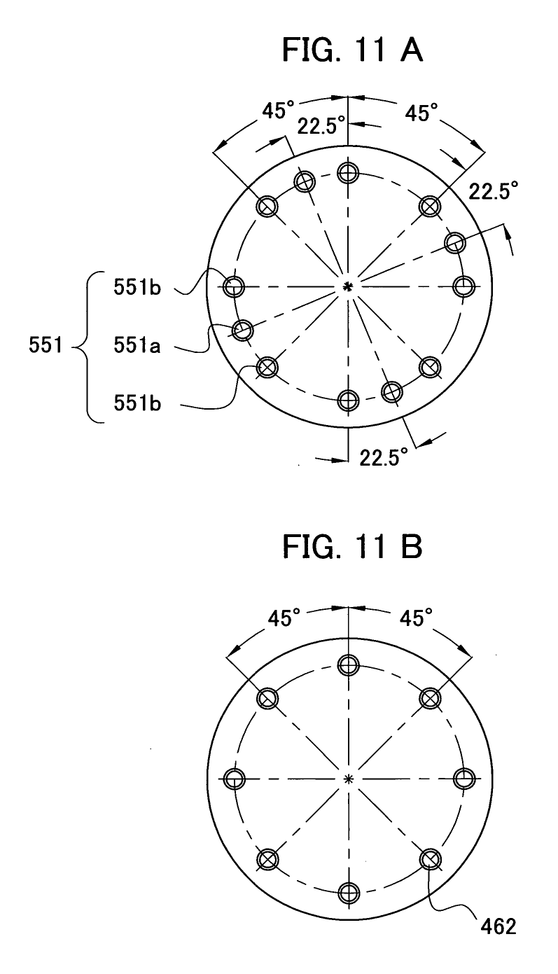

A further embodiment of the present invention's hair care equipment shall now be described. FIG. 9 is a longitudinal view showing the third embodiment of the present invention's hair care equipment, FIG. 10A and FIG. 10B shows diagrams for describing a liquid-containing part shown in FIG. 9, with FIG. 10A being a partial sectional view showing a liquid supplying opening of the liquid-containing part and FIG. 10B being an enlarged perspective view of FIG. 10A, and FIG. 1A and FIG. 1B shows schematic diagrams for describing the positioning of liquid introduction holes, formed in a supporting body of a brush part, and ejection holes, formed in a cap of the liquid-containing part, with FIG. 11A being a diagram for describing the positioning of the ejection holes and FIG. 11B being a diagram for describing the positioning of the introduction holes. For the following embodiment, components that are the same as the hair care equipment of the above embodiments shall be provided with the same symbols and redundant description shall be omitted. Also, in order to facilitate comprehension, the dimensions are adjusted suitably.

As shown in FIG. 9, a hair care equipment 10′ of above embodiment has an arrangement, wherein the hair care equipment 1 of the above embodiment has a cap 541, having ejection holes 551 formed therein, provided at a front end part of a liquid outflow opening 521 of a liquid-containing part 50′.

As with the previous embodiment, the brush part 20″ comprises a projection assembly 30″ and a supporting body 40″, and the projection assembly 30″ and the supporting body 40″ are arranged to be integrated by the replaceable fitting of the outer peripheral edge of a base plate 312 of the projection assembly 30″ into a fitting groove 422 of the supporting body 40″.

The projection assembly 30″ that makes up the brush part 20″ has the same structure as the above, and as shown in FIG. 9, has a plurality of liquid seepage projection 322 of a first projection set and projections 332 of a second projection set disposed on the base plate 312. As with all embodiments, each liquid seepage projection 322 has formed therein an outflow hole 342, which passes through from a base portion 322a to a tip portion, so that a liquid can flow through the interior thereof. Meanwhile, the projections 332 do not have outflow holes, etc., formed therein and are arranged so that a liquid will not flow through. Also, in regard to the positioning of the liquid seepage projections 322 and the projections 332, the projections 332 are positioned at an outer peripheral side of the base plate 312 so as to surround the liquid seepage projections 322, and at a central region, the liquid seepage projections 322 and the projections 332 are positioned in a mixed manner as in the first embodiment. Though these liquid seepage projections 322 and projections 332 are made to have a conical shape, rod-like shape, or other shape of the same types as those of projections of a normal hair brush and are preferably formed integral to the base plate 312, the projections are not limited thereto. Also, as with the above embodiment, the material forming the projection assembly 30″ is not restricted in particular as long as it is a material with which the liquid seepage projections 322 and the projections 332 will have a flexibility of a degree such that scalp will not be damaged and the base plate 312 of the projection assembly 30″ will have a flexibility of a degree enabling deformation by hand for fitting and mounting the outer peripheral edge thereof in the supporting body 40″.

As in the previous embodiment, the supporting body 40″ is formed to have a substantially concave-mirror-like shape that is circular in plan view, the fitting groove 422 is formed along a peripheral edge at an opening 412 side of the supporting body 40″, and a mounting member 432, which has a substantially cylindrical shape and protrudes inwards (in the direction of the projection assembly), is formed at a substantially central portion of the supporting body 40″. This mounting member 432 is opened at the outer side (in the opposite direction of the projection assembly) and has threads 442 formed on the inner surface of its side wall.

On an upper surface part 432b of the mounting member 432, protruding parts 452, which protrude in the direction of projection assembly 30″, are formed at positions that oppose the liquid seepage projections 322 when the above-mentioned projection assembly 30″ is mounted to the supporting body 40″ (see FIG. 9). These protruding parts 452 have substantially the same shape as base portions 322a of the outflow holes 342 of the liquid seepage projections 322 and have introduction holes 462 formed through in the interior thereof. As shown in FIG. 11B, eight introduction holes 462 are formed at equal intervals (at positions at which the respective central angles will be 450) along a circumference of a radius smaller than the circular shape of the upper surface part 432b of the mounting member 432. As with the above embodiment, the material making up the supporting body 40″ is preferably a material having a rigidity of a degree no less than that with which the brush part 20″ will not become deformed by scalp massaging and brushing during hair washing or styling.

The liquid-containing part 50′ is the same as that of the first embodiment and is formed, at least in part, of a material that can be deformed by the pressing pressure of a hand and to have a shape that can be gripped readily, comprises a main container body 511, which holds a liquid in the interior, and a liquid supplying opening 521, formed in a protruding manner on a front end part of the main container body 511, and has threads 531 formed on the side surface of the liquid supplying opening 521. At a front end part of the liquid supplying opening 521, the cap 541, having the plurality of ejections holes 551 formed therein, is disposed in contact with the upper surface part 432b of the mounting member 432 of the supporting member 40″. As shown in FIG. 11A, a total of twelve ejection holes 551 are formed in the cap 541. That is, along a circumference of the same radius as that along which the introduction holes 462 of the supporting body 40″ are formed, eight ejection holes 551a are formed at equal intervals (at positions at which the respective central angles will be 450) and four ejection holes 551b are formed at positions that are shifted in phase by 22.5°. Since the introduction holes 462, formed in the supporting body 40″, and the ejection holes 55a, formed in the cap 541, are formed concentrically, they overlap in a predetermined coupling state of the brush part and the liquid-containing part. In particular, by rotating either the supporting body 40″ or the cap 541 by 22.5°, the number of introduction holes 462 of the supporting body that communicate with the ejection holes 551 of the cap 541 is adjusted to eight or four. Since the amount of liquid that is ejected from the liquid-containing part 50′ can thus be adjusted by changing the number of communicating holes, the amount of outflow from the tip portions of the brush 20″ can be adjusted. Also, the mutual angle between the introduction holes 462 and the mutual angles between the ejection holes 551 that are formed concentrically are not limited to the above and may be selected as suited in accordance with the liquid amount to be adjusted. Furthermore, it is preferable to slightly raise the surroundings of the ejection holes 551 of the cap 541 in a hill-like manner so that the raised portions will fit into the introduction holes 462 of the supporting member 40″ since the communication of the ejection holes 551 and the introduction holes 462 can then be confirmed.

In the case where the introduction holes 462 and the ejection holes 551 are made the same in number, the liquid discharge amount can be varied by adjusting the size of the holes by shifting the brush 20″ part and the liquid-containing part 50′.

Though the present invention's hair care equipment has been described specifically above with reference to the drawings that illustrate examples, the present invention is inherently not limited to the illustrated examples and can be carried out upon adding modifications as suited within the scope to which the above-described gist applies, and all such modifications fall within the scope of the art of the present invention. For example, all of the projections of the projection assembly may be provided with outflow holes and arranged to discharge a liquid.

Since the present invention's hair care equipment is for humans or animals, it can be applied not only to the washing and styling of head hair and other body hairs of humans but also to the washing of body hairs of indoor dogs and other pets and animals.

1. A hair care equipment for humans or animals, comprising: a brush part and a liquid-containing part being detachably connected, wherein the brush part comprises a projection assembly having a plurality of projections; and a base plate, positioned at bases of the projections; and a supporting body having a coupling part, detachably coupled to the projection assembly;
the projection assembly has at least one liquid seepage projection, each having in its interior an outflow hole through which a liquid can flow out from the base to a hole at a tip:
the supporting body has, an introduction hole for introducing the liquid inside the liquid-containing part at a position opposing the liquid seepage projection; and
when the projection assembly and the supporting body are coupled, the outflow hole and the introduction hole are connected to form a communicating hole.

2. The hair care equipment according to claim 1, wherein the projection assembly has a protruding part, protruding from a non-projection surface of the base plate at a position which is opposite to a position where the liquid seepage projection is positioned and having a shape and size for fitting into an opening of the introduction hole, which is directed toward the projection assembly, or a recessed part having the opening, and
inside each of the protruding part, the outflow hole is disposed to extend from the interior of the liquid seepage projection to the interior of the protruding part, and when the protruding part is fitted into the opening or the recessed part, the outflow hole is connected with the introduction hole to form the communicating hole.

3. The hair care equipment according to claim 1, wherein the supporting body has a protruding part, protruding from a surface facing the projection assembly at which the introduction hole is positioned and having a shape and size for fitting into an opening of the outflow hole, which is positioned in an internal part of the base plate and that are positioned at the bases of the liquid seepage projection, or into a recessed part having the opening, and wherein
inside each of the protruding part, the introduction hole is disposed to extend from the interior of the supporting body, and when the protruding part is fitted into the opening or the recessed part, the outflow hole are connected with the introduction hole to form the communicating hole.

4. The hair care equipment according to claim 1, wherein the projection assembly has a first protruding part, protruding from the non-projection surface of the base plate at a position which is opposite to a position where the seepage projection is positioned and having the outflow hole formed in the interior thereof so as to be continuous from the interior of the liquid seepage projection:
the supporting body has a receiving part, protruding from the position of the surface facing the projection assembly at which the introduction hole is positioned and having introduction hole formed in the interior thereof in continuation to the introduction hole from the interior of the supporting body; and wherein
the outflow hole and the introduction hole is connected to form the communicating hole by the receiving part being fitted into the outflow holes inside the first protruding part or by the first protruding part being fitted into the introduction holes inside the receiving part.

5. The hair care equipment according to claim 1, wherein the projection assembly is equipped with a first projection set, comprising a liquid seepage projection in which the outflow hole is formed, and a second projection set, comprising a projection without the communicating hole,
the liquid seepage projection of the first projection set having a length dimension shorter than the projection of the second projection set.

6. The hair care equipment according to claim 1, wherein the projection assembly is low in rigidity in comparison to the supporting body.

7. The hair care equipment according to claim 1, wherein the supporting body has a supporting member supporting the projection assembly, and a mounting member mounting the liquid-containing part,
the liquid-containing part has a liquid supplying opening, which is an opening for supplying the liquid to the brush part, and a mounted member for being mounted to the supporting body, and
the mounting member and the mounted member are screwed together.

8. The hair care equipment according to claim 1, wherein a disk-like cap having one or more ejection holes formed therein for ejecting liquid, a number of which is greater than or equal to the number of the introduction hole, is mounted to a mounted member of the liquid-containing part,
the introduction hole and the ejection hole are formed along a circumference of a fixed radius from the center of rotation when the brush part and/or the liquid-containing part are rotated, and
the amount of liquid is adjustably supplied to the brush part by rotating the supporting member and/or the liquid-containing part.

9. The hair care equipment according to claim 8, wherein at least one of the ejection holes has its outer extension raised from a surface facing the supporting member for detecting the position of the ejection hole upon rotation of the brush part.

10. The hair care equipment according to claim 1, wherein at least a part of the liquid-containing part is pressingly deformable.
